(19) United States
(12) Patent Application Publication
(10) Pub. No.: US 2026/0121052 A1
(43) Pub. Date: Apr. 30, 2026

(54) NEGATIVE ELECTRODE ACTIVE MATERIAL, NEGATIVE ELECTRODE PLATE AND BATTERY

(71) Applicant: ZHUHAI COSMX BATTERY CO., LTD., Zhuhai (CN)

(72) Inventors: Hui Wang, Zhuhai (CN); Jiachen Xue, Zhuhai (CN); Chunyang Liu, Zhuhai (CN)

(21) Appl. No.: 19/319,661

(22) Filed: Sep. 4, 2025

(30) Foreign Application Priority Data
Sep. 26, 2024 (CN) 202411352896.X

(51) Int. Cl. H01M 4/587; C01B 33/029

(52) U.S. Cl. CPC H01M 4/587; C01B 33/029; C01P 2002/02; C01P 2002/72; C01P 2002/82; C01P 2004/04; C01P 2004/32; C01P 2004/61; C01P 2004/80; C01P 2006/14; C01P 2006/40

(57) ABSTRACT

A negative electrode active material comprises silicon-carbon composite particles. The silicon-carbon composite particles have a particle size Dn10 of 1 μm-8 μm. The silicon-carbon composite particles have an average sphericity of 0.6-1. The silicon-carbon composite particles have closed pores and open pores, with the volume V₁ of the closed pores and the volume V₂ of the open pores satisfying 0.2≤V₁/V₂≤2,000. The negative electrode active material of the present disclosure has good ionic conductivity and electronic conductivity and good structural stability while ensuring a high capacity per gram. The battery comprising the negative electrode active material of the present disclosure can have good initial Coulombic efficiency, rate performance, low-temperature performance and cycling stability at the same time.

### CROSS-REFERENCE TO RELATED APPLICATIONS

The present application claims priority to Chinese Patent Application No. 202411352896.X, titled “NEGATIVE ELECTRODE ACTIVE MATERIAL, NEGATIVE ELECTRODE PLATE AND BATTERY,” filed on Sep. 26, 2024, the entire contents of which are incorporated herein by reference.

### TECHNICAL FIELD

The present disclosure relates to the technical field of batteries, and in particular to a negative electrode active material, a negative electrode plate comprising the negative electrode active material, and a battery comprising the negative electrode active material.

### BACKGROUND ART

With the rapid development of fields such as consumer electronics, electric vehicles, and energy storage power stations, using silicon-based materials with a higher theoretical lithium storage capacity instead of conventional graphite materials as the negative electrode active material of a battery is an important way to further improve the energy density of a lithium-ion battery. However, the existing silicon-based materials have not only poor ionic conductivity and electronic conductivity but also a large volume expansion rate during the charge-discharge cycles of a battery, resulting in the manufactured battery having a low initial Coulombic efficiency and poor rate performance, low-temperature performance, and cycling stability.

### SUMMARY

An object of the present disclosure is to overcome the aforementioned problems of silicon-based materials in the prior art, and to provide a negative electrode active material, a negative electrode plate comprising the negative electrode active material, and a battery comprising the negative electrode active material. As for the negative electrode active material of the present disclosure, the particle size, the sphericity, and the relationship between the closed-pore volume and the open-pore volume of the silicon-carbon composite particles are simultaneously controlled, so that the negative electrode active material has better ionic conductivity and electronic conductivity as well as good structural stability while ensuring a high capacity per gram. The battery comprising the negative electrode active material of the present disclosure can have good initial Coulombic efficiency, rate performance, low-temperature performance and cycling stability at the same time.

In the related art, silicon-based materials have poor ionic conductivity and electronic conductivity as well as a large volume expansion rate. After extensive studies, the inventors of the present disclosure have found that preparing a silicon-carbon composite material and controlling the particle size, the sphericity, and the relationship between the closed-pore volume and the open-pore volume of the silicon-carbon composite particles can enable the negative electrode active material to have good ionic conductivity and electronic conductivity, good structural stability, and a small volume expansion rate while ensuring a high capacity per gram. The reasons for this may be as follows:

First, the pores in the silicon-carbon composite particles include open-pore and closed-pore structures, both of which can provide a certain degree of buffering effect on the volume expansion of the silicon material. However, there exist significant differences between the two. In a specific range, the larger the closed-pore volume is, the stronger the ability of the silicon-carbon composite particles to buffer the volume expansion of the silicon material will be, and the better the structural stability of the silicon-carbon composite particles themselves will become; however, this comes at the cost of a reduced capacity per gram of the silicon-carbon composite particles. By contrast, in a specific range, a larger open-pore volume indicates a larger contact area between the silicon-carbon composite particles and an electrolyte, which will lead to increased side reactions, thus being not conducive to the stability of the silicon-carbon composite particles, that is, adversely affecting the stability of the negative electrode active material. In addition, compared to the open-pore structure, the closed-pore structure is more conducive to the transport of lithium ions and electrons in the silicon-carbon composite particles. Therefore, to achieve balanced performance in capacity per gram, electronic conductivity, ionic conductivity and stability of the silicon-carbon composite particles, it is necessary to adjust and control the relationship between the open-pore volume and the closed-pore volume.

Secondly, only adjusting and controlling the relationship between the open-pore volume and the closed-pore volume leads to a limited improvement in the performance of the silicon-carbon composite particles. Thus, it is necessary to simultaneously control the average sphericity and particle size of the silicon-carbon composite particles. The average sphericity is an index that quantifies the morphological deviation of particles from perfect spheres. When having a spherical or near-spherical morphology, the silicon-carbon composite particles can uniformly distribute the applied stress under external compression, thus being less likely to deform or crack. Additionally, during the lithium intercalation/deintercalation of the silicon-carbon composite particles, the spherical morphology can facilitate a uniform reaction of the silicon-carbon composite particles with lithium, distribute the expansion stress that occurs when active silicon reacts with lithium, and improve the structural stability of the silicon-carbon composite particles. Dn10 is the particle size corresponding to a cumulative quantity of 10% of the total number of particles arranged in ascending order in terms of particle size. A Dn10 in a suitable range enables the silicon-carbon composite particles to have an appropriate number of active sites, thus balancing the conductivity and stability of the silicon-carbon composite particles.

Based on this, the inventors of the present disclosure propose the following solutions:

A first aspect of the present disclosure provides a negative electrode active material comprising silicon-carbon composite particles, wherein the silicon-carbon composite particles have a particle size Dn10 of 1 μm-8 μm; the silicon-carbon composite particles have an average sphericity of 0.6-1; and the silicon-carbon composite particles have closed pores and open pores, with the volume V₁ of the closed pores and the volume V₂ of the open pores satisfying 0.2≤V₁/V₂≤2,000.

A second aspect of the present disclosure provides a negative electrode plate, which comprises the negative electrode active material according to the first aspect of the present disclosure.

A third aspect of the present disclosure provides a battery, which comprises the negative electrode active material according to the first aspect of the present disclosure and/or the negative electrode plate according to the second aspect of the present disclosure.

By means of the technical solutions described above, the present disclosure has at least the following advantages over the prior art:
(1) The negative electrode active material of the present disclosure has better ionic conductivity and electronic conductivity while ensuring a higher capacity per gram.
(2) The negative electrode active material of the present disclosure has good structural stability and can maintain a low volume expansion during the charge-discharge cycles of the battery.
(3) The battery of the present disclosure can concurrently have good initial Coulombic efficiency, rate performance, low-temperature performance, and cycling stability.

The endpoints of ranges and any values disclosed herein are not limited to such exact ranges or values, and these ranges or values should be understood to include values close to these ranges or values. For numerical value ranges, one or more new numerical value ranges can be obtained between endpoint values of various ranges, between endpoint values of various ranges and individual point values, and between individual point values, and these numerical value ranges should be regarded as specifically disclosed herein.

### BRIEF DESCRIPTION OF THE DRAWINGS

FIG. 1 shows a schematic diagram of “open pores” and “closed pores”.

FIG. 2 shows a transmission electron microscope (TEM) image of silicon-carbon composite particles in an embodiment of the present disclosure.

### DETAILED DESCRIPTION OF EMBODIMENTS

Hereinafter, specific embodiments of the present disclosure will be described in detail. It should be understood that the specific embodiments described herein are only used to illustrate and explain the present disclosure and are not used to limit the present disclosure.

A first aspect of the present disclosure provides a negative electrode active material, which may comprise silicon-carbon composite particles. The particle size Dn10 of the silicon-carbon composite particles may be 1 μm-8 μm, for example, 1 μm, 2 μm, 3 μm, 4 μm, 5 μm, 6 μm, 7 μm or 8 μm. The average sphericity of the silicon-carbon composite particles may be 0.6-1, for example, 0.6, 0.65, 0.7, 0.75, 0.8, 0.85, 0.86, 0.87, 0.88, 0.89, 0.9, 0.91, 0.92, 0.93, 0.94, 0.95, 0.96, 0.97, 0.98, 0.99 or 1. The silicon-carbon composite particles may have closed pores and open pores, and the volume V₁ of the closed pores and the volume V₂ of the open pores satisfy 0.2≤V₁/V₂≤2,000, for example, 0.2, 1, 5, 10, 20, 30, 40, 50, 60, 70, 80, 90, 100, 200, 300, 400, 500, 600, 700, 800, 900, 1,000, or 2,000.

When Dn10 is small (for example, less than 1 m), there are relatively more particles with a small particle size in the silicon-carbon composite particles. The increase in specific surface area due to the size effect leads to more side reactions between the silicon-carbon composite particles and the electrolyte, resulting in a reduced initial Coulombic efficiency and volumetric energy density of the battery. When Dn10 is large (for example, larger than 8 m), there are relatively more particles with a large particle size in the silicon-carbon composite particles, resulting in a longer migration path of lithium ions in the silicon-carbon composite particles, which reduces not only the conductivity but also the capacity utilization of the silicon-carbon composite particles, thus affecting the volumetric energy density and rate performance of the battery.

An average sphericity of 1 indicates that the silicon-carbon composite particles have a perfect spherical morphology. An excessively low average sphericity (for example, less than 0.6) of the silicon-carbon composite particles indicates that most silicon-carbon composite particles deviate from spherical geometry, exhibiting an irregular shape. The particles with irregular shapes generally have protruding portions that are likely to press against the separator and the current collector in the battery, exacerbating the self-discharge of the battery and deteriorating the storage performance.

A small V₁/V₂ (for example, less than 0.2) indicates a small volume of the closed pores relative to that of the open pores. In this case, the silicon-carbon composite particles exhibit large volume expansion and low ionic conductivity and electronic conductivity, which result in a low initial Coulombic efficiency and volumetric energy density of the battery, along with a large volume expansion rate during cycling. A large V₁/V₂ (for example, greater than 2,000) indicates that the volume of the closed pores predominates over that of the open pores, and such silicon-carbon composite particles have a low true density, which is not conducive to the volumetric energy density of the battery.

In the present disclosure, the particle size Dn10 of the silicon-carbon composite particles can be measured by a conventional method in the art, for example, by a laser-based particle-size measurement method using a Malvern particle size analyzer, and the specific measurement steps are as follows: the silicon-carbon composite particles are dispersed in a dispersant (for example, nonylphenol polyoxyethylene ether)-containing deionized water (with the mass content of the dispersant being 0.02%-0.03%), ultrasonicated for 2 min, and then placed in a Malvern particle size analyzer for measurement.

In the present disclosure, the average sphericity of the silicon-carbon composite particles can be measured by a conventional method in the art. For example, using an image processing software (for example, Image Pro Plus), at least 10 silicon-carbon composite particles in a scanning electron microscope (SEM) image of the silicon-carbon composite particles at a magnification (for example 2,500×) are selected to measure and calculate the perimeter and area of each particle; then, the perimeter-equivalent radius r₁ and the area-equivalent radius r₂ of each silicon-carbon composite particle are calculated, with the sphericity being r₂/r₁; and then the resulting values are averaged to obtain the average sphericity of the silicon-carbon composite particles.

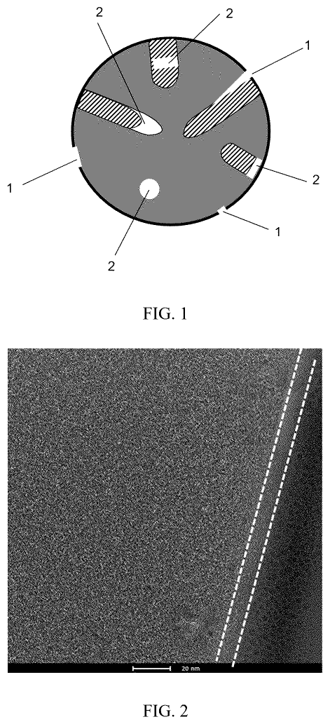

In the present disclosure, the open pore and the closed pore have conventional meanings in the art. The open pore generally refers to a pore that is interconnected with the exterior surface of a silicon-carbon composite particle; and the closed pore generally refers to a pore inside a silicon-carbon composite particle that is not interconnected with the exterior surface thereof. FIG. 1 shows a schematic diagram of the “open pores” and “closed pores”. As can be seen from the figure, a silicon-carbon composite particle has closed pores 2 and open pores 1.

In the present disclosure, the volume of the open pores can be measured by a conventional method in the art, for example, by a gas adsorption method. The volume of the closed pores can be calculated based on the mass content of the silicon element and carbon element in the silicon-carbon composite particles and the true density of the silicon-carbon composite particles. The specific calculation equation is as follows: V₁=(1/c)−1/(2.31×C₂+2.33×C₃), where C₂ is the mass content of the silicon element in the silicon-carbon composite particles, C₃ is the mass content of the carbon element in the silicon-carbon composite particles (C₃ can be measured by means of scanning electron microscopy-energy dispersive spectroscopy (SEM-EDS)), and c is the true density of the silicon-carbon composite particles.

In an embodiment, 1≤V₁/V₂≤400.

In an embodiment, 2≤V₁/V₂≤200.

In an embodiment, the particle size Dn10 of the silicon-carbon composite particle is 3 μm-6 μm.

In an embodiment, the average sphericity of the silicon-carbon composite particle is 0.8-1.

In the present disclosure, the volume V₁ of the closed pores may be 0.001 cm³/g-0.4 cm³/g, for example, 0.001 cm³/g, 0.005 cm³/g, 0.01 cm³/g, 0.05 cm³/g, 0.1 cm³/g, 0.2 cm³/g, 0.3 cm³/g or 0.4 cm³/g.

In an embodiment, the volume V₁ of the closed pores is 0.01 cm³/g-0.2 cm³/g.

In the present disclosure, the volume V₂ of the open pores may be 0.0001 cm³/g-0.1 cm³/g, for example, 0.0001 cm³/g, 0.0005 cm³/g, 0.001 cm³/g, 0.005 cm³/g, 0.01 cm³/g, 0.05 cm³/g or 0.1 cm³/g.

In an embodiment, the volume V₂ of the open pores is 0.0005 cm³/g-0.05 cm³/g.

In the present disclosure, the silicon-carbon composite particle may include a core-shell structure. FIG. 2 shows a transmission electron microscope (TEM) image of silicon-carbon composite particles in an embodiment of the present disclosure. As can be seen from the figure, both silicon and carbon at the core of the silicon-carbon composite particle are amorphous and evenly and densely distributed, without obvious phase interfaces. The outer surface of the core has a shell with a thickness of about 10 nm.

In the present disclosure, the core of the core-shell structure may comprise a carbon element and a silicon element. The shell of the core-shell structure may comprise a carbon element.

In an embodiment, the core comprises porous carbon and a silicon material located in the pores of the porous carbon.

In an embodiment, the shell comprises amorphous carbon.

In the present disclosure, the silicon-carbon composite particle may comprise an oxygen element. The doping of the oxygen element in the silicon-carbon composite particles can increase the reaction sites between the silicon-carbon composite particles and lithium ions, thereby improving the diffusion coefficient of lithium ions.

In the present disclosure, in the silicon-carbon composite particles, the ratio C₂/C₁ of the mass content C₂ of the silicon element to the mass content C₁ of the oxygen element may be 10.5-26,500, for example, 10.5, 13.3, 20, 21.6, 30, 40, 50, 60, 70, 80, 90, 100, 200, 300, 400, 500, 600, 650, 700, 800, 900, 1,000, 2,000, 3,000, 4,000, 5,000, 6,000, 7,000, 8,000, 9,000, 10,000, 20,000 or 26,500.

In an embodiment, C₂/C₁ is 13.3-650.

In an embodiment, C₂/C₁ is 21.6-400.

By controlling C₂/C₁, the negative electrode active material can have balanced capacity per gram and ionic conductivity. The doping of the oxygen element can improve the diffusion coefficient of lithium ions in the silicon-carbon composite particles, which not only can improve the overall ionic conductivity of the negative electrode active material, but also is beneficial for the capacity utilization. However, excessive oxygen element will occupy the mass of the silicon element, reducing the capacity per gram of the negative electrode active material. Therefore, it is necessary to adjust and control the contents of the silicon element and the oxygen element in a specific range that enables the negative electrode active material to have balanced capacity per gram and conductivity, thereby improving the energy density and rate performance of the battery.

In the present disclosure, the mass content C₂ of the silicon element in the silicon-carbon composite particle may be 30%-75%, for example, 30%, 35%, 40%, 45%, 50%, 55%, 60%, 65%, 70% or 75%.

In an embodiment, C₂ is 40%-65%.

In the present disclosure, the mass content C₁ of the oxygen element in the silicon-carbon composite particle may be 20 ppm-50,000 ppm, for example, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm, 1,000 ppm, 2,000 ppm, 3,000 ppm, 4,000 ppm, 5,000 ppm, 6,000 ppm, 7,000 ppm, 8,000 ppm, 9,000 ppm, 10,000 ppm, 20,000 ppm, 30,000 ppm, 40,000 ppm or 50,000 ppm.

In an embodiment, C₁ is 1,000 ppm-30,000 ppm.

In the present disclosure, the mass content C₂ of the silicon element and the mass content C₁ of the oxygen element in the silicon-carbon composite particle can be measured using a conventional method in the art, for example, by means of scanning electron microscopy-energy dispersive spectroscopy (SEM-EDS).

In the present disclosure, the silicon-carbon composite particles may further comprise at least one of a potassium element, a calcium element and a sodium element.

The doping of at least one of the potassium element, calcium element, and sodium element in the silicon-carbon composite particles can increase the electronic conductivity of the silicon-carbon composite particles and reduce the resistivity of the silicon-carbon composite particles. When the silicon-carbon composite particles are doped with both the oxygen element and at least one of the potassium element, calcium element and sodium element, not only the transport efficiency of lithium ions but also the transport efficiency of electrons can be improved, thus being more conducive to improving the rate performance and low-temperature performance of the battery.

In an embodiment, the silicon-carbon composite particles comprise potassium element, calcium element and sodium element.

In the present disclosure, the sum of the mass contents of the potassium element, calcium element and sodium element in the silicon-carbon composite particles may be 30 ppm-10,000 ppm, for example, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm, 1,000 ppm, 2,000 ppm, 3,000 ppm, 4,000 ppm, 5,000 ppm, 6,000 ppm, 7,000 ppm, 8,000 ppm, 9,000 ppm or 10,000 ppm.

In an embodiment, the sum of the mass contents of the potassium element, calcium element and sodium element in the silicon-carbon composite particles is 100 ppm-500 ppm.

Provided that C₂/C₁ satisfies a specific relationship, by controlling the sum of the mass contents of the potassium element, calcium element and sodium element in the silicon-carbon composite particles, the transport speed of electrons can match with the transport speed of ions in the silicon-carbon composite particles, which is conducive to improving the capacity utilization and the conductivity of the silicon-carbon composite particles, thereby improving the energy density and rate performance of the battery.

In the present disclosure, the mass contents of the potassium element, calcium element and sodium element in the silicon-carbon composite particles can be measured by a conventional method in the art, for example, by using inductively coupled plasma atomic emission spectrometry (ICP-AES), and the specific measurement method is as follows: an ICP-6800 inductively coupled plasma emission spectrometer from Macylab Instruments Inc. is used for measurement; and during the measurement, samples are digested using nitric acid and hydrofluoric acid, and the content of each element is measured by performing calibration using a standard solution of a corresponding element, under conditions of an ambient temperature of 25° C.±2° C., a plasma gas flow rate of 15 mL/min, and a sample introduction pump flow rate of 1.5 mL/min.

In the present disclosure, a Raman spectrum of the silicon-carbon composite particles may have a first characteristic peak at 470 cm⁻¹-480 cm⁻¹, a second characteristic peak at 507 cm⁻¹-517 cm⁻¹, a third characteristic peak at 1,330 cm⁻¹-1,350 cm⁻¹, and a fourth characteristic peak at 1,590 cm⁻¹-1,610 cm⁻¹. The intensity I₁ of the first characteristic peak, the intensity I₂ of the second characteristic peak, the intensity I₃ of the third characteristic peak and the intensity I₄ of the fourth characteristic peak satisfy 0.5≤(I₁+I₃)/(I₂+I₄)≤3, for example, 0.5, 0.6, 0.65, 0.7, 0.8, 0.9, 1, 1.5, 2, 2.4, 2.5 or 3.

In an example, 0.65≤(I₁+I₃)/(I₂+I₄)≤2.4.

The intensity I₁ of the first characteristic peak can indicate the degree of disorder of silicon in the silicon-carbon composite particles, the intensity I₂ of the second characteristic peak can indicate the degree of order of silicon in the silicon-carbon composite particles, the intensity I₃ of the third characteristic peak can indicate the degree of disorder of carbon in the silicon-carbon composite particles, and the intensity I₄ of the fourth characteristic peak can indicate the degree of order of carbon in the silicon-carbon composite particles. A higher degree of disorder of silicon and carbon in the silicon-carbon composite particles indicates more loosely packed structures of silicon and carbon, which facilitate the transfer of lithium ions from the electrolyte into the interior of the silicon-carbon composite particles and promote the diffusion of lithium ions within the silicon-carbon composite particles. However, the higher the degree of disorder of silicon and carbon in the silicon-carbon composite particles, the greater the risk of side reactions between the silicon-carbon composite particles and the electrolyte. Thus, it is necessary to control the relationship between the degree of disorder and the degree of order of silicon and carbon in the silicon-carbon composite particles to achieve a balance between the two, thus enabling the negative electrode active material to maintain both stability and ionic conductivity. When (I₁+I₃)/(I₂+I₄) is excessively low (for example, less than 0.5), the degree of disorder of silicon and carbon in the silicon-carbon composite particles is lower relative to the degree of order, which increases the resistance to lithium-ion intercalation into the silicon-carbon composite particles, thus being not conducive to the transport of lithium ions. When (I₁+I₃)/(I₂+I₄) is excessively high (for example greater than 3), the degree of disorder of silicon and carbon in the silicon-carbon composite particles is higher relative to the degree of order, which leads to increased side reactions between the silicon-carbon composite particles and the electrolyte and reduces the capacity per gram and stability of the silicon-carbon composite particles, thus affecting the initial Coulombic efficiency and cycling stability of the battery.

In the present disclosure, the Raman spectrum of the silicon-carbon composite particles can be obtained using a conventional measurement method in the art, for example, using a Thermo Fisher Raman spectrometer, with the measurement wavenumber set in the range of 400 cm⁻¹-4,000 cm⁻¹.

In the present disclosure, an XRD diffraction spectrum of the silicon-carbon composite particles has a first diffraction peak at 27.4°-29.4°, and a second diffraction peak at 42.4°-44.4°. The full width at half maximum W₁ of the first diffraction peak and the full width at half maximum W₂ of the second diffraction peak satisfy 3°≤W₁+W₂≤35°, for example, 3°, 4°, 5°, 10°, 15°, 20°, 25°, 30° or 35°.

In an embodiment, 4°≤W₁+W₂≤20°.

In the XRD diffraction spectrum of the silicon-carbon composite particles, the first diffraction peak corresponds to the characteristic peak of silicon, and the second diffraction peak corresponds to the characteristic peak of carbon. When the full width at half maximum of the first diffraction peak and the full width at half maximum of the second diffraction peak satisfy the aforementioned relationship, the silicon and carbon in the silicon-carbon composite particles have a proper degree of amorphization, which is conducive to the transport of lithium ions in the silicon-carbon composite particles. When W₁+W₂ is small (for example, less than 3°), the degree of crystallization of silicon and carbon in the bulk of the silicon-carbon composite particles is relatively high, which is not conducive to the rapid intercalation/deintercalation of lithium ions. When W₁+W₂ is large (for example, greater than 35°), the degree of amorphization of silicon and carbon in the bulk of the silicon-carbon composite particles is relatively high, and there are more defects in the crystal structure of the particles, which defects will irreversibly consume lithium ions during the first charge and discharge process of the battery, resulting in a low initial Coulombic efficiency of the battery.

In the present disclosure, the XRD diffraction spectrum of the silicon-carbon composite particles can be obtained using a conventional test method in the art, for example, by using an X-ray diffraction method, where an XRD-6100 X-ray diffractometer from Shimadzu is used, a sample size used for the test is 0.5 g/cm², Cu Kα line is used as the incident X-ray, the operating voltage of the X-ray source is 40 kV, the test power is 2 kW, 2θ (in °) is plotted on the horizontal coordinate and the signal intensity is recorded on the vertical coordinate, and the test range is 100-80°, with a scanning rate of 4°/min and a data collection interval of 0.02°.

In the present disclosure, a first-cycle dQ/dV curve of a button half-cell comprising the silicon-carbon composite particles has a characteristic peak I at 0.25 V-0.3 V, and a characteristic peak II at 0.4 V-0.45 V. The ratio of the peak intensity of the characteristic peak I to the peak intensity of the characteristic peak II may be 1-3, for example, 1, 1.05, 1.5, 2, 2.5 or 3.

In an embodiment, the ratio of the peak intensity of the characteristic peak I to the peak intensity of the characteristic peak II is 1.05-2.5.

During the discharge process of a button half-cell or the charge process of a lithium-ion battery (a full-cell), silicon will form a lithium-silicon alloy, and the characteristic peak I and the characteristic peak II respectively correspond to the conversion of Li₁₅₊ₓSi₄ into Li₁₅Si₄ and the conversion of Li₁₅Si₄ into LiₓSi in the lithium-silicon alloy. Since the structural difference between Li₁₅₊ₓSi₄ and Li₁₅Si₄ is small and the structural difference between Li₁₅Si₄ and LiₓSi is significant, the volume change rate of the lithium deintercalation process corresponding to the characteristic peak II is higher. When the peak intensity of the characteristic peak I and the peak intensity of the characteristic peak II satisfy the aforementioned relationship, it indicates that during the lithium deintercalation of the silicon-carbon composite particles, the Li₁₅Si₄ produced in the process corresponding to characteristic peak I is rapidly converted into LiₓSi, without too much accumulation of Li₁₅Si₄ in the material. Therefore, the process corresponding to characteristic peak II occurs less, and the volume change rate of the silicon-carbon composite particles is small. That is, the silicon-carbon composite particles have good structural stability, and the battery comprising the negative electrode active material has a good cycling capacity retention rate.

In the present disclosure, the first-cycle dQ/dV curve of a button half-cell comprising the silicon-carbon composite particles can be obtained by a conventional method in the art. For example, a button half-cell is prepared using the silicon-carbon composite particles, and the button half-cell is discharged at 0.05C to 5 mV and then charged at 0.05C to 1.5 V; and in a data processing software (for example, a LANHE battery testing system-data processing software) for the button half-cell, “Voltage-dQ/dV” is selected, and the vertical coordinates of the highest points in the ranges of 0.25-0.3 V and 0.4-0.45 V of the dQ/dV curve corresponding to the first-cycle lithium deintercalation section in the graph are collected to indicate the intensity of the characteristic peak I and characteristic peak II, respectively, and the ratio thereof is calculated.

Here, the preparation method of the button half-cell is as follows: the silicon-carbon composite particles, an 4 wt % aqueous polyacrylic acid solution, and conductive carbon black are mixed in a mass ratio of 80:10:10 to prepare a slurry; the slurry is coated onto a surface of a copper foil and dried to obtain a single-sided negative electrode plate; the negative electrode plate is then cut, using a slicer, into a 12 mm small disc, which is assembled into a 2016 button half-cell, together with a metal lithium plate as a counter electrode, a 1 mol/L lithium hexafluorophosphate-ethylene carbonate/dimethyl carbonate (1:1 by volume) solution as the electrolyte, and a Celgard separator. During the test of the dQ/dV curve, the resulting cell is charged and discharged at a current density of 0.1C in a range of 5 mV-1.5 V.

In the present disclosure, the rate of change of the particle size Dv50 of the silicon-carbon composite particles after being subjected to a pressure of 377 MPa may be 0-50%, for example, 0, 1%, 2%, 3%, 4%, 5%, 6%, 7%, 8%, 9%, 10%, 20%, 30%, 40% or 50%.

In an embodiment, after applying a pressure of 377 MPa to the silicon-carbon composite particles, the rate of change of the particle size Dv50 of the silicon-carbon composite particles is 0-10%.

After subjecting the silicon-carbon composite particles to a pressure of 377 MPa, if the rate of change of the particle size Dv50 is within a specific range, it indicates that the silicon-carbon composite particles have high mechanical strength and are less likely to deform when exposed to external stress, which is conducive to improving the cycling stability of the battery.

In the present disclosure, “the rate of change of the particle size Dv50 of the silicon-carbon composite particles after being subjected to a pressure of 377 MPa” refers to the ratio of the difference between the particle sizes Dv50 of the silicon-carbon composite particles before and after being subjected to a pressure of 377 MPa to the particle size Dv50 of the silicon-carbon composite particles before being subjected to a pressure of 377 MPa.

In the present disclosure, the specific step of “subjecting the silicon-carbon composite particles to a pressure of 377 MPa” is as follows: 1 g of the silicon-carbon composite particles is applied with a pressure of 377 MPa using a powder compactor (for example, a SUNS 300 kN computer-controlled electronic powder compaction tester) and maintained at the pressure for 30 s, and then the pressure is removed to obtain a powder.

The Dv50 is the particle size corresponding to a cumulative volume distribution of 50% when particles are arranged in ascending order in terms of particle size. The particle size Dv50 of the silicon-carbon composite particles can be measured by a conventional method in the art, for example, by a laser-based particle-size measurement method. The specific method is the same as the measurement of Dn10.

In the present disclosure, the true density of the silicon-carbon composite particles may be 1.5 g/cm³-2.25 g/cm³, for example, 1.5 g/cm³, 1.7 g/cm³, 1.75 g/cm³, 2 g/cm³, 2.15 g/cm³ or 2.25 g/cm³. A suitable true density range enables the silicon-carbon composite particles to have sufficient closed-pore volume to buffer the volume expansion of silicon, thus allowing the battery to have better cycling retention rates and thickness expansion rates.

In an example, the true density of the silicon-carbon composite particles is 1.7 g/cm³-2.15 g/cm³.

In the present disclosure, the true density of the silicon-carbon composite particles can be tested using a conventional method in the art. For example, a gas volume displacement method is used, which is specifically stated as follows: the test is performed using a JW-M100A fully-automated true density tester from JWGB Instrument, with helium as a test gas, at an ambient temperature of 25° C.±2° C.

The present disclosure further provides a method for preparing the silicon-carbon composite particles described above, which includes at least the following steps:
placing a porous carbon material in a vapor deposition apparatus, introducing argon, and raising the temperature to 400° C.-1,000° C. and holding for 0.5 h-12 h, and then reducing the temperature to 300° C.-500° C.; performing a first introduction of silane gas, followed by a second introduction of silane gas; and stopping the introduction of silane gas, raising the temperature to 500° C.-650° C., and then introducing acetylene gas for 0.5 h-6 h.

In the present disclosure, the flow rate of the first introduction is 50 sccm-300 sccm; and the duration of the first introduction is 1 h-6 h.

In the present disclosure, the flow rate of the second introduction is 100 sccm-200 sccm; and the duration of the first introduction is 1 h-3 h.

In the present disclosure, the flow rate of the introduced acetylene gas is 50 sccm-200 sccm; and the duration of the acetylene gas introduction is 0.5 h-6 h.

In the present disclosure, the method further includes a pre-treatment of the porous carbon material before placing same in a vapor deposition apparatus.

In the present disclosure, the pre-treatment may include soaking the porous carbon material with a solvent. The solvent may include at least one of potassium hydroxide, sodium hydroxide and calcium hydroxide. The concentration of the solvent is, for example, 0.5 mol/L-2 mol/L. The content of the porous carbon in the solvent may be 0.1 g/100 mL-5 g/100 mL. The duration of the soaking may be 1 h-72 h.

A second aspect of the present disclosure provides a negative electrode plate, which comprises the negative electrode active material according to the first aspect of the present disclosure.

In the present disclosure, the negative electrode plate may comprise a negative electrode current collector and a negative electrode active material layer located on a surface on at least one side of the negative electrode current collector.

In the present disclosure, an XRD diffraction spectrum of the negative electrode active material layer may have a third diffraction peak at 25°-30°, and a fourth diffraction peak at 42°-44°. The full width at half maximum W₃ of the third diffraction peak and the full width at half maximum W₄ of the fourth diffraction peak satisfy 0.10≤W₃+W₄≤35°, for example, 0.1°, 0.5°, 10, 2°, 3°, 5°, 10°, 15°, 20°, 25°, 300 or 35°.

In an embodiment, 0.5°≤W₃+W₄≤20°.

In the present disclosure, in a first-cycle dQ/dV curve of a button half-cell comprising the negative electrode plate, the ratio of the maximum value at 0.25 V-0.3 V to the maximum value at 0.4 V-0.45 V may be 1-15, for example, 1, 2, 3, 4, 5, 6, 7, 8, 9, 10, 11, 12, 13, 14 or 15.

In an embodiment, in a first-cycle dQ/dV curve of the button half-cell comprising the negative electrode plate, the ratio of the maximum value at 0.25 V-0.3 V to the maximum value at 0.4 V-0.45 V is 1.5-10.

In the present disclosure, the negative electrode active material layer may further comprise a negative electrode conductive agent and a negative electrode binder. The negative electrode conductive agent may include at least one of conductive carbon black, acetylene black, Ketjen black, conductive graphite, carbon nanotubes (including at least one of single-walled carbon nanotubes and multi-walled carbon nanotubes) and carbon fibers. The negative electrode binder may include at least one of polyvinylidene fluoride (PVDF), sodium carboxymethyl cellulose, styrene-butadiene rubber, polytetrafluoroethylene, polyethylene oxide, polyacrylic acid, and derivatives thereof.

In the present disclosure, the negative electrode active material may further comprise a carbon-based material. The carbon-based material may include at least one of artificial graphite, natural graphite, mesocarbon microbeads, soft carbon and hard carbon. The mass ratio of the silicon-carbon composite particles to the carbon-based material may be 1:(0.01-50), for example 1:0.01, 1:0.05, 1:0.1, 1:0.5, 1:1, 1:5, 1:10, 1:19, 1:20, 1:30, 1:40 or 1:50.

In an embodiment, the mass ratio of the silicon-carbon composite particles to the carbon-based material is 1:(0.1-19).

In the present disclosure, based on the total mass of the negative electrode active material layer, the content of the negative electrode active material may be 80%-99.8% (for example, 80%, 82%, 84%, 86%, 88%, 90%, 92%, 94%, 96%, 98%, 99% or 99.8%), the content of the negative electrode conductive agent may be 0.1%-10% (for example, 10%, 9%, 8%, 7%, 6%, 5%, 4%, 3%, 2%, 1%, 0.5% or 0.1%), and the content of the negative electrode binder may be 0.1%-10% (for example, 10%, 9%, 8%, 7%, 6%, 5%, 4%, 3%, 2%, 1%, 0.5% or 0.1%).

A third aspect of the present disclosure provides a battery, which may comprise the negative electrode active material according to the first aspect of the present disclosure and/or the negative electrode plate according to the second aspect of the present disclosure.

In the present disclosure, a third-cycle discharge dQ/dV curve of the battery has a characteristic peak III at 3.6 V-3.7 V, and a characteristic peak IV at 3.8 V-4.0 V. The ratio of the peak intensity of the characteristic peak III to the peak intensity of the characteristic peak IV may be 1-10, for example, 1, 2, 3, 4, 5, 6, 7, 8, 9 or 10.

In an embodiment, the ratio of the peak intensity of the characteristic peak III to the peak intensity of the characteristic peak IV is 2-6.

In the present disclosure, the components (for example, a positive electrode plate, a separator and an electrolyte) of the battery in addition to the negative electrode plate may be common choices in the art.

In an embodiment, the battery further comprises a positive electrode plate. The positive electrode plate comprises a positive electrode active material, and the positive electrode active material includes at least one of lithium cobalt oxide, lithium nickel cobalt manganese oxide, lithium nickel cobalt aluminum oxide, lithium nickel cobalt manganese aluminum oxide, lithium manganese oxide, lithium nickel manganese oxide, lithium nickel oxide, lithium iron phosphate, lithium manganese iron phosphate, lithium vanadium phosphate, and a lithium-rich manganese-based material.

In an embodiment, the battery includes a lithium-ion battery.

In an embodiment, the battery includes a lithium-ion secondary battery.

It should be noted that the digital representations such as “first” and “second” in the present disclosure are only used to distinguish different materials or usage modes and do not represent the difference in order.

The present disclosure will be described in detail below by means of examples. The examples described in the present disclosure are only some, rather than all, of the examples of the present disclosure. Based on the examples in the present disclosure, all other examples obtained by those of ordinary skill in the art without involving creative effort belong to the scope of protection of the present disclosure.

In the following examples, unless otherwise specified, all the materials used are commercially available and analytically pure.

The following preparation examples are used to prepare the silicon-carbon composite particles of the present disclosure.

### Preparation Example 1

The silicon-carbon composite particles were prepared according to the following method:
(1) Pre-treatment of porous carbon: a porous carbon material (with a Dn10 of 5 μm and a sphericity of 0.99) was placed, in a ratio of 1 g/100 mL, in a mixed solution of potassium hydroxide, sodium hydroxide and calcium hydroxide (with the total concentration of potassium hydroxide and sodium hydroxide being 1 mol/L, and the calcium hydroxide solution being saturated) and left to stand for 12 h, then taken out, washed, and dried; and
(2) the resulting material was placed in a vapor deposition furnace, argon was introduced, and the temperature was raised to a temperature of 1,000° C., held for 4 h and then reduced to 500° C., and then silane gas with a flow rate of 100 seem and 200 seem was sequentially introduced for 2 h each; and then the introduction of silane was stopped, the temperature was raised to 520° C., and acetylene gas was introduced at a flow rate of 100 seem for 2 h.

Here, the silicon-carbon composite particles had a Dn10 of 5 m and an average sphericity of 0.99; V₁ was about 0.2 cm³/g, V₂ was about 0.001 cm³/g, and V₁/V₂ was 200; C₂ was about 53%, C₁ was about 21,000 ppm, and C₂/C₁ was 25.24; and the sum of the contents of the potassium element, calcium element and sodium element was about 300 ppm.

### Preparation Example 2

The silicon-carbon composite particles were prepared according to the following method:
(1) Pre-treatment of porous carbon: a porous carbon material (with a Dn10 of 3 m and a sphericity of 0.91) was placed, in a ratio of 1 g/100 mL, in a mixed solution of potassium hydroxide, sodium hydroxide and calcium hydroxide (with the total concentration of potassium hydroxide and sodium hydroxide being 1 mol/L, and the calcium hydroxide solution being saturated) and left to stand for 4 h, then taken out, washed, taken out, washed and dried; and
(2) the resulting material was placed in a vapor deposition furnace, argon was introduced, and the temperature was raised to 1,000° C., held for 2 h and then reduced to 500° C., and then silane gas with a flow rate of 250 seem and 150 seem was sequentially introduced for 2 h each; and then the introduction of silane was stopped, the temperature was raised to 620° C., and acetylene gas was introduced at a flow rate of 100 seem for 4 h.

Here, the silicon-carbon composite particles had a Dn10 of 3 m and an average sphericity of 0.91; V₁ was about 0.01 cm³/g, V₂ was about 0.0005 cm³/g, V₁/V₂ was 20; C₂ was about 65%, C₁ was about 30,000 ppm, and C₂/C₁ was 21.67; and the sum of the contents of the element potassium, element calcium and element sodium was about 100 ppm.

### Preparation Example 3

The silicon-carbon composite particles were prepared according to the following method:
(1) Pre-treatment of porous carbon: a porous carbon material (with a Dn10 of 6 m and a sphericity of about 0.8) was placed, in a ratio of 1 g/100 mL, in a mixed solution of potassium hydroxide, sodium hydroxide and calcium hydroxide (with the total concentration of potassium hydroxide and sodium hydroxide being 1 mol/L, and the calcium hydroxide solution being saturated) and left to stand for 20 h, then taken out, washed, taken out, washed and dried; and
(2) the resulting material was placed in a vapor deposition furnace, argon was introduced, and the temperature was raised to 1,000° C., held for 8 h and then reduced to 500° C., and then silane gas with a flow rate of 150 seem and 100 seem was sequentially introduced for 2 h each; and then the introduction of silane was stopped, the temperature was raised to 560° C., and acetylene gas was introduced at a flow rate of 100 seem for 1 h.

Here, the silicon-carbon composite particles had a Dn10 of 6 m and an average sphericity of 0.8; V₁ was about 0.1 cm³/g, V₂ was about 0.05 cm³/g, and V₁/V₂ was 2; C₂ was about 40%, C₁ was about 1,000 ppm, and C₂/C₁ was 400; and the sum of the contents of the potassium element, calcium element and sodium element was about 500 ppm.

### Preparation Example 4

This example was used to verify the effect of the change of “V₁/V₂”.

This example was carried out with reference to Preparation example 2, except that V₁/V₂ was adjusted and controlled by changing the volume V₂ of the open pores, specifically as follows:
in step (2), after stopping the introduction of silane, the temperature was raised to 560° C., and acetylene gas was introduced at a flow rate of 100 seem for 1 h.

Here, V₂ was about 0.05 cm³/g, and V₁/V₂ was 0.2; The other parameters were substantially the same as those in Preparation example 2.

### Preparation Example 5 Group

This group of preparation examples was used to verify the effect of the change of “Dn10”.

This group of preparation examples was carried out with reference to Preparation example 1, except that the Dn10 of the silicon-carbon composite particles was adjusted and controlled by changing the Dn10 of the porous carbon material, specifically as follows:
in Preparation example 5a, the Dn10 of the porous carbon material was 1 m; and
in Preparation example 5b, the Dn10 of the porous carbon material was 8 m.

### Preparation Example 6 Group

This group of preparation examples was used to verify the effect of the change of “average sphericity”.

This group of preparation examples was carried out with reference to Preparation example 1, except that the average sphericity of the silicon-carbon composite particles was adjusted and controlled by changing the average sphericity of the porous carbon material, specifically as follows:
in Preparation example 6a, the average sphericity of the porous carbon material was 0.71; and
in Preparation example 6b, the average sphericity of the porous carbon material was 0.6.

### Preparation Example 7 Group

This group of preparation examples was used to verify the effect of the change of “the V₁ of closed pores”.

This group of preparation examples was carried out with reference to Preparation example 1, except that V₁ was adjusted and controlled by changing the flow rate and duration of silane introduction, specifically as follows:
in Preparation example 7a, in step (2), after reducing the temperature to 500° C., silane was first introduced at a flow rate of 50 sccm for 6 h and then at a flow rate of 200 sccm for 3 h,
where V₁ was about 0.001 cm³/g, and V₁/V₂ was 1; and C₂ was about 75%, and C₂/C₁ was 37.5; and
in Preparation example 7b, in step (2), after reducing the temperature to 500° C., silane was first introduced at a flow rate of 300 sccm for 1 h and then at a flow rate of 100 sccm for 1 h,
where V₁ was about 0.4 cm³/g, and V₁/V₂ was 400; and C₂ was about 30%, and C₂/C₁ was 15.

### Preparation Example 8 Group

This group of preparation examples was used to verify the effect of the change of “the volume V₂ of open pores”.

This group of preparation examples was carried out with reference to Preparation example 1, except that V₂ was adjusted and controlled by changing the duration of the introduction of acetylene gas, specifically as follows:
in Preparation example 8a, in step (2), acetylene gas was introduced at a flow rate of 100 seem for 6 h,
where V₂ was about 0.0001 cm³/g, and V₁/V₂ was 2,000; and
in Preparative example 8b, in step (2), acetylene gas was introduced at a flow rate of 100 seem for 0.5 h,
where V₂ was about 0.1 cm³/g, and V₁/V₂ was 2.

### Preparation Example 9

This example was used to verify the effect of the change of “the core-shell structure”.

In step (2), after stopping the introduction of silane, no acetylene gas was introduced to obtain the silicon-carbon composite particles (without a shell).

### Preparation Example 10 Group

This group of preparation examples was used to verify the effect of the change of “C₂/C₁”.

This group of preparation examples was carried out with reference to Preparation example 2 and Preparation example 3, respectively, except that C₂/C₁ was adjusted and controlled by changing the holding time at 1,000° C. after introducing argon to porous carbon and raising the temperature to 1,000° C., specifically as follows:

Preparation example 10a was carried out with reference to Preparation example 2, and in step (2), after placing the porous carbon in a vapor deposition furnace, argon was introduced, and the temperature was raised to 1,000° C., held for 8 h and then reduced to 500° C.,
where, C₂ was about 65%, C₁ was about 1,000 ppm, and C₂/C₁ was 650; and

Preparation example 10b was carried out with reference to Preparation example 3, and in step (2), after placing the porous carbon in a vapor deposition furnace, argon was introduced, and the temperature was raised to 1,000° C., held for 0.5 h and then reduced to 500° C.,
where C₂ was about 40%, C₁ was about 30,000 ppm, and C₂/C₁ was 13.33.

### Preparation Example 11 Group

This group of preparation examples was used to verify the effect of the change of “the mass content C₁ of the oxygen element”.

This group of preparation examples was carried out with reference to Preparation example 1, except that C₁ was adjusted and controlled by changing the temperature of introducing argon to porous carbon and/or the holding time, specifically as follows:
in Preparation example 11a, in step (2), argon was introduced and the temperature was raised to 1,000° C. and held for 12 h,
where C₂ was about 53%, C₁ was about 20 ppm, and C₂/C₁ was 26,500; and
in Preparation example 11b, in step (2), argon was introduced and the temperature was raised to 400° C. and held for 8 h,
where C₂ was about 53%, C₁ was about 50,000 ppm, and C₂/C₁ was 10.6.

### Preparation Example 12 Group

This group of preparation examples was used to verify the effect of the change of “the potassium element, calcium element and sodium element”.

This group of preparation examples was carried out with reference to Preparation example 1, except that the pre-treatment conditions of the porous carbon were modified to make a change in the potassium element, calcium element and sodium element, specifically as follows:
in Preparation example 12a, the mixed solution of potassium hydroxide, sodium hydroxide and calcium hydroxide in step (1) was replaced with a saturated solution of calcium hydroxide, and the soaking time was 15 h, where the content of the calcium element was about 300 ppm; and
in Preparation example 12b, the porous carbon in step (1) was not subjected to pre-treatment.

### Preparation Example 13 Group

This group of preparation examples was used to verify the effect of the change of “the sum of the contents of the potassium element, calcium element and sodium element”.

This group of preparation examples was carried out with reference to Preparation example 1, except that the sum of the contents of the potassium element, calcium element and sodium element was adjusted and controlled by changing the duration of the pre-treatment of the porous carbon, specifically as follows:
in Preparation example 13a, in step (1), the porous carbon was soaked in the mixed solution for 1 h,
where the sum of the contents of the potassium element, calcium element and sodium element was about 30 ppm; and
in Preparation example 13b, in step (1), the porous carbon was soaked in the mixed solution for 72 h,
where the sum of the contents of the potassium element, calcium element and sodium element was about 10,000 ppm.

The shell of the silicon-carbon composite particles prepared in the preparation examples above comprises amorphous carbon.

### Comparative Preparation Example 1

This example was carried out with reference to Preparation example 1, except that the porous carbon material used had a Dn10 of 0.5 m and an average sphericity of 0.99, and the resulting silicon-carbon composite particles had a Dn10 of 0.5 m and an average sphericity of 0.99.

### Comparative Preparation Example 2

This example was carried out with reference to Preparation example 1, except that the porous carbon material used had a Dn10 of 10 m and an average sphericity of 0.99, and the resulting silicon-carbon composite particles had a Dn10 of 10 m and an average sphericity of 0.99.

### Comparative Preparation Example 3

This example was carried out with reference to Preparation example 1, except that the porous carbon material used had a Dn10 of 5 m and an average sphericity of 0.5, and the resulting silicon-carbon composite particles had a Dn10 of 5 m and an average sphericity of 0.5.

### Comparative Preparation Example 4

This example was carried out with reference to Preparation example 1, except that in step (2), after the temperature was reduced to 500° C., silane was first introduced at a flow rate of 50 seem for 6 h and then at a flow rate of 200 seem for 1 h, and then the introduction of silane was stopped, the temperature was raised to 520° C., and acetylene gas was introduced at a flow rate of 100 seem for 0.5 h, where V₁ was about 0.001 cm³/g, V₂ was about 0.1 cm³/g, V₁/V₂ was 0.01, and C₂ was about 75%.

### Comparative Preparation Example 5

This example was carried out with reference to Preparation example 1, except that in step (2), after the temperature was reduced to 500° C., silane was first introduced at a flow rate of 300 seem for 1 h and then at a flow rate of 100 seem for 1 h, and then the introduction of silane was stopped, the temperature was raised to 520° C., and acetylene gas was introduced at a flow rate of 100 seem for 6 h, where V₁ was about 0.4 cm³/g, V₂ was about 0.0001 cm³/g, V₁/V₂ was 4,000, and C₂ was about 30%.

### Test Example I

### (1) Raman Spectroscopy Test

The silicon-carbon composite particles prepared in Preparation examples 1-3 were tested by means of Raman spectroscopy. The results are recorded in Table 1. The results of the other preparation examples all satisfy 0.65≤(I₁+I₃)/(I₂+I₄)≤2.4.

### (2) XRD Test

The silicon-carbon composite particles prepared in Preparation examples 1-3 were tested by means of XRD. The results are recorded in Table 1. The results of the other preparation examples all satisfy 4°≤W₁+W₂≤20°.

(3) dQ/dV Curve

The button half-cells prepared using the silicon-carbon composite particles prepared in Preparation examples 1-3 were subjected to a first-cycle dQ/dV curve test. The results are recorded in Table 1. The results of the other preparation examples all satisfied the ratio of the peak intensity of the characteristic peak I to the peak intensity of the characteristic peak II being 1.05-2.5.

### (4) Mechanical Testing

The silicon-carbon composite particles prepared in the preparation examples were tested under a pressure of 377 MPa. The results showed that the rate of change of the particle size Dv50 of the prepared silicon-carbon composite particles prepared in all preparation examples, except for the preparation example 6 group, was 0-10%; and the rate of change of the particle size Dv50 in the preparation example 6 group was 0-50%.

### (5) True Density Test

The silicon-carbon composite particles prepared in the preparation examples were tested for the true density. The results showed that the silicon-carbon composite particles prepared in all the preparation examples had a true density of 1.5 g/cm³-2.25 g/cm³, where the true density of the silicon-carbon composite particles prepared in Preparation examples 1-3 was 1.7 g/cm³, 2.15 g/cm³ and 1.95 g/cm³, respectively.

TABLE 1

| | | | Ratio of peak intensity of characteristic |
|---|---|---|---|
| | (I₁ + I₃)/ | W₁ + | peak I to peak intensity of |
| | (I₂ + I₄) | W₂ | characteristic peak II |
| Preparation | 1.143 | 10° | 1.6 |
| example 1 | | | |
| Preparation | 2.40 | 4° | 1.06 |
| example 2 | | | |
| Preparation | 0.657 | 20° | 2.5 |
| example 3 | | | |

The following examples are used to illustrate the battery of the present disclosure.

### Example 1

The preparation method was as follows:

### (1) Preparation of Negative Electrode Plate

Artificial graphite, the silicon-carbon composite particles prepared in Preparation example 1, sodium carboxymethyl cellulose, styrene-butadiene rubber and Super P were mixed in a mass ratio of 87.7:8.8:1.6:1.6:0.3, deionized water was added, and the mixture was subjected to the action of a vacuum mixer to obtain a negative electrode slurry; and the negative electrode slurry was uniformly coated onto the surfaces on both sides of a copper foil, dried in an oven at 80° C. for 12 h, and then subjected to rolling and slitting to obtain a negative electrode plate.

### (2) Preparation of Positive Electrode Plate

Lithium cobalt oxide, polyvinylidene fluoride, acetylene black and carbon nanotubes were mixed in a mass ratio of 96:2:1.5:0.5, N-methylpyrrolidone was added, and the mixture was stirred under the action of a vacuum mixer until a uniform positive electrode slurry was formed; and the positive electrode slurry was uniformly coated onto the surfaces on both sides of an aluminum foil, baked in an oven, then transferred to an oven for drying at 120° C. for 8 h, and then subjected to rolling and slitting to obtain a positive electrode plate.

### (3) Preparation of Lithium-Ion Battery

The negative electrode plate prepared in step (1), a separator (a polyethylene film with a thickness of 8 μm), and the positive electrode plate prepared in step (2) were sequentially stacked to ensure that the separator was between the positive electrode plate and the negative electrode plate and functioned for isolation, and then wound to obtain a bare cell; and the bare cell was placed in an aluminum plastic film casing, and an electrolyte (obtained by dissolving lithium hexafluorophosphate in a mixed solution comprising ethylene carbonate/dimethyl carbonate (1:1 by volume) and 5 vol. % fluoroethylene carbonate, with the concentration of lithium hexafluorophosphate being 1 mol/L) was injected into the dried bare cell, followed by procedures such as vacuum packaging, standing, formation, shaping, and sorting to obtain a lithium-ion battery.

### (4) Preparation of Button Half-Cell

The silicon-carbon composite particles prepared in Preparation example 1, Super P, sodium carboxymethyl cellulose and styrene-butadiene rubber were mixed in a mass ratio of 96.5:1.6:1.6:0.3, deionized water was added, and the mixture was mixed until uniform under the action of a vacuum mixer to obtain a negative electrode slurry for a button cell; the negative electrode slurry for a button cell was coated onto a copper foil, dried in an oven at 80° C., and then transferred to a vacuum oven for drying at 100° C. for 12 h to obtain a negative electrode plate with an areal density of about 3 mg/cm²; in a dry environment, the negative electrode plate was punched into a negative electrode disc with a diameter of 12 mm, using a punching machine; and in a glove box, the negative electrode disc as a working electrode, a metal lithium plate as a counter electrode, a 20 m thick polyethylene separator as a separator, and an electrolyte (obtained by dissolving lithium hexafluorophosphate in a mixed solution comprising ethylene carbonate/dimethyl carbonate (1:1 by volume) and 5 vol. % fluoroethylene carbonate, with the concentration of lithium hexafluorophosphate being 1 mol/L) were assembled into a button half-cell.

Example 2 to Example 13 group and Comparative examples 1-5 were carried out with reference to Example 1, except that the silicon-carbon composite particles prepared in Preparation example 1 were replaced, and the details were shown in Table 2.

### Example 14 Group

This group of examples was used to verify the effect of the change of “the mass ratio of the silicon-carbon composite particles to the carbon-based material”.

This group of examples was carried out with reference to Example 1, except that the mass ratio of the silicon-carbon composite particles to artificial graphite was changed, specifically as follows:
in Example 14a, artificial graphite, the silicon-carbon composite particles prepared in Preparation example 1, sodium carboxymethyl cellulose, styrene-butadiene rubber and Super P were mixed in a mass ratio of 8.8:87.7:1.6:1.6:0.3;
in Example 14b, artificial graphite, the silicon-carbon composite particles prepared in Preparation example 1, sodium carboxymethyl cellulose, styrene-butadiene rubber and Super P were mixed in a mass ratio of 91.7:4.8:1.6:1.6:0.3;
in Example 14c, artificial graphite, the silicon-carbon composite particles prepared in Preparation example 1, sodium carboxymethyl cellulose, styrene-butadiene rubber and Super P were mixed in a mass ratio of 94.6:1.9:1.6:1.6:0.3; and
in Example 14d, the silicon-carbon composite particles prepared in Preparation example 1, sodium carboxymethyl cellulose, styrene-butadiene rubber and Super P were mixed in a mass ratio of 96.5:1.6:1.6:0.3.

### Test Example II

(1) XRD test of negative electrode active material layer

The negative electrode active material layers prepared in Example 1 to Example 14 group were tested by means of XRD, and the results were as follows: W₃+W₄ in Example 1 was 0.5°, W₃+W₄ in Example 2 was 20°, W₃+W₄ in Example 3 was 10.1°, and the results of the other examples all satisfied 0.5°≤W₃+W₄≤20°.

(2) dQ/dV Curve

The negative electrode plates prepared in Example 1 to Example 14 group were made into button half-cells and subjected to a first-cycle dQ/dV curve test, and the results were as follows: the ratio of the maximum value at 0.25 V-0.3 V to the maximum value at 0.4 V-0.45 V was 1.6 in Example 1, which was 10 in Example 2 and 1.53 in Example 3. The results of the other examples all satisfied the ratio of the maximum value at 0.25 V-0.3 V to the maximum value at 0.4 V-0.45 V being 1.5-10.

The batteries prepared in Example 1 to Example 14 group were subjected to a dQ/dV test, and the results of the third-cycle discharge dQ/dV curve of the batteries were as follows: the ratio of the peak intensity of characteristic peak I to the peak intensity of characteristic peak II was 2 in Example 1, which was 2 in Example 14a, 6 in Example 14b, 10 in Example 14c, and 1 in Example 14d. The results of the other examples all satisfied 1-10.

### (3) Cycling Test

The lithium-ion batteries prepared in the examples and comparative examples were subjected to a cycling test, and the specific test method was as follows:

A battery was charged at a constant current with a current density of 2C to 4.5 V, then charged at a constant voltage of 4.5 V to a cut-off current of 0.05C, and then left to stand for 10 min, and the thickness of the battery at this time was measured and recorded as an initial thickness; then, the battery was discharged to 3.0 V at a current density of 1.5C, and then left to stand for 10 min, and the discharge capacity of the battery at this time was recorded as an initial capacity; and the charge-discharge process described above was repeated until the constant-voltage charge process at the 500th cycle was completed, the battery was left to stand for 10 min, and then the thickness of the battery was measured and recorded as the thickness after cycling; and then the battery was discharged at a current density of 1.5C to 3.0 V and left to stand for 10 min, and the discharge capacity of the battery at this time was recorded as the capacity after cycling. The cycling capacity retention rate=the capacity after cycling×100%/initial capacity, and the thickness expansion rate=(the thickness after cycling−initial thickness)×100%/initial thickness. The cycling capacity retention rate and the thickness expansion rate were recorded in Table 2.

### (4) Energy Density Test

The lithium-ion batteries prepared in the examples and comparative examples were subjected to an energy density test, and the specific test method was as follows:

A battery was charged at a constant current with a current density of 0.2C to 4.5 V, then charged at a constant voltage of 4.5 V to a cut-off current of 0.02C, left to stand for 10 min, then discharged at a constant current with a current density of 0.2C to 3.0 V, and left to stand for 10 min, and the first-cycle discharge capacity and the first-cycle discharge energy of the battery were recorded; and the battery was then charged at a constant current with a current density of 0.2C until the cut-off condition that the charge capacity reached half of the initial discharge capacity was satisfied; and after the cut-off, the battery was removed to measure the thickness, length and width of the battery, and the energy density of the battery=first-cycle discharge energy/(length×width×thickness). The results are recorded in Table 2.

### (5) Initial Coulombic Efficiency Test

The button half-cells prepared in Example 1 to Examples 13 group and the comparative examples were tested for the initial Coulombic efficiency, and the specific test method was as follows:

After leaving to stand for 2 h, the battery was discharged at a constant current with a current density of 0.1C to 5 mV, left to stand for 10 min, then discharged at a current density of 0.01C to 5 mV, left to stand again for 10 min, and then charged at a constant current with a current density of 0.05C to 1.5 V. The initial Coulombic efficiency=charge capacity×100%/discharge capacity. The results are recorded in Table 2.

### (6) Rate Performance Test

The lithium-ion batteries prepared in the examples and comparative examples were subjected to a discharge rate capacity test, and the specific test method was as follows:

A battery was charged at a constant current with a current density of 0.2C to 4.5 V, then charged at a constant voltage of 4.5 V to a cut-off current of 0.02C, left to stand for 10 min, and then discharged at a current density of 0.2C and 1C respectively to 3.0 V, and the ratio of the capacity discharged at 1C to the capacity discharged at 0.2C is the discharge rate capability of the battery. The results are recorded in Table 3.

### (7) Self-Discharge Test

The lithium-ion batteries prepared in the examples and comparative examples were subjected to a self-discharge test, and the specific test method was as follows:

A battery was charged at a constant current with a current density of 0.2C to 4.5 V, then charged at a constant voltage of 4.5 V to a cut-off current of 0.02C, and left to stand for 10 min, and then the open-circuit voltage V₁ of the battery was recorded; and the battery was then left to stand for 24 h, and the open-circuit voltage V₂ of the battery after standing was recorded. The degree of self-discharge k of the battery=(V₁−V₂)/24 (in mV/h). The results are recorded in Table 3.

### (8) Storage Performance Test

The lithium-ion batteries prepared in the examples and comparative examples were subjected to a storage performance test, and the specific test method of was as follows:

A battery was charged at a constant current with a current density of 0.2C to 4.5 V, then charged at a constant voltage of 4.5 V to a cut-off current of 0.02C, left to stand for 10 min, then discharged at a constant current with a current density of 0.2C to 3.0 V, and left to stand for 10 min, and the first-cycle discharge capacity of the battery was recorded; the battery was then charged at a constant current with a current density of 0.2C until the cut-off condition that the charge capacity reached half of the initial discharge capacity was satisfied; and after the cut-off, the battery was removed to measure the thickness of the battery, which was recorded as the thickness before storage; and the battery was then charged at a constant current with a current density of 0.2C to 4.5 V, then charged at a constant voltage of 4.5 V to a cut-off current of 0.02C, and then left to stand in a blast drying oven at 60° C. for 35 days. The thickness of the battery at the end of the storage was measured and recorded as the thickness after storage. The thickness expansion rate of the battery after 35 days of storage at 60° C.=(the thickness after storage−the thickness before storage)/the thickness before storage. The results are recorded in Table 3.

### (9) Low-Temperature Performance Test

The lithium-ion batteries prepared in the examples and comparative examples were subjected to a low-temperature performance test, and the specific test method was as follows:

A battery was charged at a constant current with a current density of 0.2C to 4.5 V, then charged at a constant voltage of 4.5 V to a cut-off current of 0.02C, left to stand for 10 min, and then discharged to 3.0 V at a current density of 0.2C at an ambient temperature of 25° C. and −20° C. respectively. The ratio of the capacity discharged at −20° C. to the capacity discharged at 25° C. was the low-temperature discharge capability of the battery. The results are recorded in Table 3.

### (10) Ion Diffusion Coefficient Test

The button half-cells prepared in Example 1 to Example 13 group and the comparative examples were subjected to an ion diffusion coefficient test, and the specific test method was as follows:

After 2 h of standing, a button half-cell was discharged at a constant current with a current density of 0.1C to 5 mV and left to stand for 10 min; the cell was then discharged at a current density of 0.01C to 5 mV and left to stand again for 10 min; the cell was then charged at a constant current with a current density of 0.05C to 1.5 V and left to stand again for 10 min; the process of discharging the cell at a constant current with a current density of 0.1C for 30 min and leaving same to stand for 30 min was repeated until the voltage of the cell was less than 0.1 V, and the battery was left to stand again for 30 min, and the voltage E1 at this time was recorded; and then the cell was discharged at a constant current with a current density of 0.1C for 30 min, and the voltage E2 at the time when the discharge was performed for 10 s and the voltage E3 at the time of cut-off were recorded; and then the cell was left to stand for 60 min, and the voltage E4 after 60 min of standing was recorded. According to the equation:

$$D = \frac{4}{π τ} {( \frac{nV}{S} )}^{2} {( \frac{E 1 - E 4}{E 2 - E 3} )}^{2} ,$$

the lithium-ion diffusion coefficient (in cm²/s) of the silicon-carbon composite particles with a potential of 0.1 V (vs Li⁺/Li) can be obtained, where r is relaxation time, i.e., τ=3,600 s; n is the number of moles of the silicon-carbon composite particles, V is the molar volume of the silicon-carbon composite particles, and n×V is the volume of the silicon-carbon composite particles used for test, which can be calculated based on the mass w of the coating in the negative electrode plate of the button half-cell and the true density p of the silicon-carbon composite particles, i.e., n×V=0.965×w/ρ; and S is the geometric area of the negative electrode plate of the button half-cell, i.e., S=1.13 cm². The results are recorded in Table 3.

TABLE 2

| | | | Thick- | | |
|---|---|---|---|---|---|
| | Silicon- | Cycling | ness | | |
| | carbon | capacity | expan- | Energy | Initial |
| | composite | retention | sion | density | Coulombic |
| | particles | rate | rate | (Wh/L) | efficiency |
| Example 1 | Preparation | 91.40% | 8.67% | 844 | 92.50% |
| | example 1 | | | | |
| Example 2 | Preparation | 91.10% | 8.90% | 849 | 92.90% |
| | example 2 | | | | |
| Example 3 | Preparation | 91.50% | 8.56% | 840 | 92.00% |
| | example 3 | | | | |
| Example 4 | Preparation | 88.60% | 10.71% | 823 | 89.30% |
| | example 4 | | | | |
| Example 5a | Preparation | 90.30% | 9.05% | 825 | 89.60% |
| | example 5a | | | | |
| Example 5b | Preparation | 91.30% | 8.98% | 826 | 92.10% |
| | example 5b | | | | |
| Example 6a | Preparation | 90.80% | 8.99% | 841 | 92.30% |
| | example 6a | | | | |
| Example 6b | Preparation | 90.60% | 8.91% | 841 | 92.20% |
| | example 6b | | | | |
| Example 7a | Preparation | 89.10% | 10.03% | 830 | 90.00% |
| | example 7a | | | | |
| Example 7b | Preparation | 91.90% | 8.40% | 817 | 92.10% |
| | example 7b | | | | |
| Example 8a | Preparation | 90.20% | 9.97% | 814 | 90.40% |
| | example 8a | | | | |
| Example 8b | Preparation | 90.50% | 9.06% | 831 | 90.90% |
| | example 8b | | | | |
| Example 9 | Preparation | 89.30% | 9.17% | 835 | 91.20% |
| | example 9 | | | | |
| Example 10a | Preparation | 90.90% | 9.03% | 837 | 91.60% |
| | example 10a | | | | |
| Example 10b | Preparation | 90.10% | 9.05% | 812 | 89.80% |
| | example 10b | | | | |
| Example 11a | Preparation | 90.70% | 9.02% | 839 | 91.90% |
| | example 11a | | | | |
| Example 11b | Preparation | 90.30% | 9.74% | 812 | 88.30% |
| | example 11b | | | | |
| Example 12a | Preparation | 91.00% | 9.02% | 836 | 91.80% |
| | example 12a | | | | |
| Example 12b | Preparation | 90.80% | 9.11% | 834 | 91.70% |
| | example 12b | | | | |
| Example 13a | Preparation | 90.30% | 9.08% | 838 | 91.20% |
| | example 13a | | | | |
| Example 13b | Preparation | 90.40% | 9.06% | 811 | 91.40% |
| | example 13b | | | | |
| Example 14a | Preparation | 91.00% | 8.99% | 850 | / |
| | example 1 | | | | |
| Example 14b | Preparation | 91.60% | 8.52% | 841 | / |
| | example 1 | | | | |
| Example 14c | Preparation | 91.70% | 8.51% | 819 | / |
| | example 1 | | | | |
| Example 14d | Preparation | 89.80% | 10.12% | 851 | / |
| | example 1 | | | | |
| Comparative | Comparative | 81.50% | 14.23% | 801 | 86.60% |
| example 1 | preparation | | | | |
| | example 1 | | | | |
| Comparative | Comparative | 89.30% | 10.06% | 799 | 90.20% |
| example 2 | preparation | | | | |
| | example 2 | | | | |
| Comparative | Comparative | 89.50% | 10.01% | 816 | 89.70% |
| example 3 | preparation | | | | |
| | example 3 | | | | |
| Comparative | Comparative | 57.30% | 19.61% | 822 | 89.30% |
| example 4 | preparation | | | | |
| | example 4 | | | | |
| Comparative | Comparative | 89.80% | 9.96% | 781 | 85.90% |
| example 5 | preparation | | | | |
| | example 5 | | | | |

TABLE 3

| | | | Thickness | Low- | Lithium- |
|---|---|---|---|---|---|
| | Rate | | expansion | temper- | ion |
| | dis- | k | rate after | ature | diffusion |
| | charge | value | 35 days | discharge | coefficient |
| | capability | (mV/h) | of storage | capability | (cm²/s) |
| Example 1 | 95.80% | 0.011 | 3.78% | 68.80% | 9.0 × 10⁻¹¹ |
| Example 2 | 95.60% | 0.013 | 3.82% | 68.70% | 8.7 × 10⁻¹¹ |
| Example 3 | 95.20% | 0.025 | 3.99% | 68.50% | 9.6 × 10⁻¹¹ |
| Example 4 | 95.10% | 0.017 | 7.52% | 68.10% | 8.1 × 10⁻¹¹ |
| Example 5a | 95.70% | 0.014 | 7.43% | 68.70% | 6.9 × 10⁻¹¹ |
| Example 5b | 91.30% | 0.022 | 4.01% | 63.40% | 6.3 × 10⁻¹¹ |
| Example 6a | 95.10% | 0.107 | 7.14% | 68.70% | 6.5 × 10⁻¹¹ |
| Example 6b | 95.00% | 0.113 | 7.53% | 68.50% | 6.3 × 10⁻¹¹ |
| Example 7a | 95.20% | 0.027 | 6.94% | 68.00% | 7.7 × 10⁻¹¹ |
| Example 7b | 91.10% | 0.016 | 4.02% | 68.10% | 6.3 × 10⁻¹¹ |
| Example 8a | 91.00% | 0.026 | 6.01% | 67.90% | 5.5 × 10⁻¹¹ |
| Example 8b | 95.10% | 0.023 | 5.87% | 68.70% | 7.8 × 10⁻¹¹ |
| Example 9 | 92.00% | 0.045 | 4.93% | 64.30% | 5.3 × 10⁻¹¹ |
| Example 10a | 93.60% | 0.031 | 4.07% | 64.90% | 8.6 × 10⁻¹² |
| Example 10b | 94.70% | 0.033 | 4.22% | 67.60% | 8.1 × 10⁻¹¹ |
| Example 11a | 91.80% | 0.027 | 4.13% | 64.70% | 3.5 × 10⁻¹² |
| Example 11b | 95.30% | 0.032 | 4.86% | 68.30% | 7.9 × 10⁻¹¹ |
| Example 12a | 93.70% | 0.023 | 4.55% | 65.20% | 5.5 × 10⁻¹¹ |
| Example 12b | 90.10% | 0.02 | 4.92% | 63.50% | 5.2 × 10⁻¹¹ |
| Example 13a | 91.20% | 0.024 | 4.32% | 64.00% | 9.1 × 10⁻¹² |
| Example 13b | 94.90% | 0.043 | 4.57% | 68.10% | 4.7 × 19⁻¹¹ |
| Example 14a | 95.90% | 0.029 | 4.00% | 69.20% | / |
| Example 14b | 95.10% | 0.011 | 3.77% | 68.10% | / |
| Example 14c | 92.20% | 0.012 | 3.74% | 63.50% | / |
| Example 14d | 93.10% | 0.046 | 4.68% | 65.20% | / |
| Comparative | 93.60% | 0.044 | 8.92% | 67.10% | 3.1 × 10⁻¹¹ |
| example 1 | | | | | |
| Comparative | 87.30% | 0.261 | 5.13% | 60.80% | 1.5 × 10⁻¹³ |
| example 2 | | | | | |
| Comparative | 91.60% | 0.397 | 9.55% | 65.40% | 2.7 × 10⁻¹¹ |
| example 3 | | | | | |
| Comparative | 91.40% | 0.285 | 5.82% | 64.20% | 5.3 × 10⁻¹³ |
| example 4 | | | | | |
| Comparative | 90.30% | 0.061 | 9.13% | 63.90% | 2.7 × 10⁻¹² |
| example 5 | | | | | |

Notes:
the initial Coulombic efficiency and lithium-ion diffusion coefficient were measured using a button half-cell; since the button half-cells in the Example 14 group were the same as that in Example 1, the Example 14 group was not subjected to the initial Coulombic efficiency and lithium-ion diffusion coefficient tests, and “/” in Table 2 and Table 3 indicates “not tested”.

As can be seen from Table 2 and Table 3, the battery prepared from the negative electrode active material of the present disclosure can have better initial Coulombic efficiency, rate performance, low-temperature performance and cycling stability at the same time, compared to those in the comparative examples.

The preferred embodiments of the present disclosure have been described in detail above; however, the present disclosure is not limited thereto. Within the technical concept of the present disclosure, various simple modifications can be made to the technical solution of the present disclosure, including the combination of various technical features in any other suitable way. These simple modifications and combinations should also be regarded as the content disclosed by the present disclosure and all fall within the scope of protection of the present disclosure.

1. A negative electrode active material, comprising:
silicon-carbon composite particles, wherein
the silicon-carbon composite particles have a particle size Dn10 of 1 μm-8 μm;
the silicon-carbon composite particles have an average sphericity of 0.6-1; and
the silicon-carbon composite particles have closed pores and open pores, with a volume V₁ of the closed pores and a volume V₂ of the open pores satisfying
0.2≤V₁/V₂≤2,000.

2. The negative electrode active material according to claim 1, wherein 1≤V₁/V₂≤400, preferably, 2≤V₁/V₂≤200;
and/or, the silicon-carbon composite particles have a particle size Dn10 of 3 μm-6 μm;
and/or, the silicon-carbon composite particles have an average sphericity of 0.8-1;
and/or, the volume V₁ of the closed pores is 0.001 cm³/g-0.4 cm³/g, preferably 0.01 cm³/g-0.2 cm³/g;
and/or, the volume V₂ of the open pores is 0.0001 cm³/g-0.1 cm³/g, preferably 0.0005 cm³/g-0.05 cm³/g.

3. The negative electrode active material according to claim 1, wherein the silicon-carbon composite particles comprise a core-shell structure, wherein a core of the core-shell structure comprises a carbon element and a silicon element, and a shell of the core-shell structure comprises a carbon element; and
preferably, the core comprises porous carbon and a silicon material located in the pores of the porous carbon; and
preferably, the shell comprises amorphous carbon.

4. The negative electrode active material according to claim 1, wherein the silicon-carbon composite particles comprise an oxygen element; and
preferably, in the silicon-carbon composite particles, a ratio C₂/C₁ of a silicon element content C₂ to an oxygen element content C₁ is 10.5-26,500, more preferably 21.6-400.

5. The negative electrode active material according to claim 4, wherein C₂ is 30%-75%, preferably 40%-65%;
and/or, C₁ is 20 ppm-50,000 ppm, preferably 1,000 ppm-30,000 ppm.

6. The negative electrode active material according to claim 1, wherein the silicon-carbon composite particles comprise at least one of a potassium element, a calcium element, and a sodium element;
preferably, the silicon-carbon composite particles comprise the potassium element, the calcium element and the sodium element; and
more preferably, the sum of mass contents of the potassium element, the calcium element and the sodium element in the silicon-carbon composite particles is 30 ppm-10,000 ppm, preferably 100 ppm-500 ppm.

7. The negative electrode active material according to claim 1, wherein a Raman spectrum of the silicon-carbon composite particles has a first characteristic peak at 470 cm⁻¹-480 cm⁻¹, a second characteristic peak at 507 cm⁻¹-517 cm⁻¹, a third characteristic peak at 1,330 cm⁻¹-1,350 cm⁻¹, and a fourth characteristic peak at 1,590 cm⁻¹-1,610 cm⁻¹; and an intensity I₁ of the first characteristic peak, an intensity I₂ of the second characteristic peak, an intensity I₃ of the third characteristic peak, and an intensity I₄ of the fourth characteristic peak satisfy 0.5≤(I₁+I₃)/(I₂+I₄)≤3, preferably, 0.65≤(11+I₃)/(I₂+I₄)≤2.4;
and/or, an XRD diffraction spectrum of the silicon-carbon composite particles has a first diffraction peak at 27.4°-29.4°, and a second diffraction peak at 42.4°-44.4°; and a full width at half maximum W₁ of the first diffraction peak and a full width at half maximum W₂ of the second diffraction peak satisfy 3°≤W₁+W₂≤35°, preferably 4°≤W₁+W₂≤20°;
and/or, a first-cycle dQ/dV curve of a button half-cell comprising the negative electrode active material has a characteristic peak I at 0.25 V-0.3 V, and a characteristic peak II at 0.4 V-0.45 V; and a ratio of a peak intensity of the characteristic peak I to a peak intensity of the characteristic peak II is 1-3, preferably 1.05-2.5;
and/or, after rolling the silicon-carbon composite particles under 377 MPa, a rate of change of a particle size Dv50 of the silicon-carbon composite particles is 0-50%, preferably 0-10%.

8. A negative electrode plate, comprising a negative electrode active material according to claim 1.

9. The negative electrode plate according to claim 8, wherein the negative electrode plate comprises a negative electrode current collector and a negative electrode active material layer located on a surface on at least one side of the negative electrode current collector; and the negative electrode active material layer comprises the negative electrode active material;
an XRD diffraction spectrum of the negative electrode active material layer has a third diffraction peak at 250-30°, and a fourth diffraction peak at 42°-44°; and a full width at half maximum W₃ of the third diffraction peak and a full width at half maximum W₄ of the fourth diffraction peak satisfy 0.1°≤W₃+W₄≤35°, preferably 0.5°≤W₃+W₄≤20°;
and/or, in a first-cycle dQ/dV curve of a button half-cell comprising the negative electrode plate, a ratio of the maximum value at 0.25 V-0.3 V to the maximum value at 0.4 V-0.45 V is 1-15, preferably 1.5-10.

10. A battery, comprising a negative electrode active material according to claim 1.

11. The battery according to claim 10, wherein a third-cycle discharge dQ/dV curve of the battery has a characteristic peak III at 3.6 V-3.7 V, and a characteristic peak IV at 3.8 V-4.0 V; and a ratio of a peak intensity of the characteristic peak III to a peak intensity of the characteristic peak IV is 1-10, preferably 2-6.

12. A battery, comprising a negative electrode plate according to claim 8.
